(19) United States
(12) Patent Application Publication
(10) Pub. No.: US 2005/0132858 A1
(43) Pub. Date: Jun. 23, 2005

(54) Punch stripper

(76) Inventors: Minoru Hayashi, Osaka (JP); Hideo Nakatani, Osaka (JP); Tooru Etsuda, Osaka (JP)

Correspondence Address: BIRCH STEWART KOLASCH & BIRCH, PO BOX 747, FALLS CHURCH, VA, 22040-0747, US

(21) Appl. No.: 10/885,727

(22) Filed: Jul. 8, 2004

(30) Foreign Application Priority Data
Dec. 22, 2003 (JP) 2003-424011

(51) Int. Cl. B26D 5/16

(52) U.S. Cl. 83/627; 83/635

(57) ABSTRACT

The invention provides inexpensively a pierce die by omitting a large pad at the time of executing a piercing process and pressing a work at only a minimum portion required for the piercing process, thereby reducing the portion to be machined as much as possible. There is provided a punch stripper comprising a pierce punch, a punch retainer holding the pierce punch, a cover which covers the pierce punch so as to protrude a leading end portion of the pierce punch, and is fastened by screws to the punch retainer, a stripper which is outward fitted to the pierce punch, presses the work before piercing the work by the pierce punch, takes out the pierce punch from the work after piercing, is received within the cover so as to move forward and backward, and forms a stop flange in a rear end, and a coil spring which is received within the cover so as to bring the stripper into contact with the stop flange, and energizes the stripper toward an outer side.

### BACKGROUND OF THE INVENTION

The present invention relates to a punch stripper, which is structured by uniting a conventional piercing punch and a conventional stripper.

A conventional piecing process is executed as shown in FIG. 19. A work W is mounted on a work supporting member 102 firmly fixed to a lower die base plate 101, a pad.103 pressing the work W is hanged downward from a hanging bolt 105 provided in an upper die base plate 104, the pad 103 is energized toward a lower side by a coil spring 106 contracted between the pad 103 and the upper die base plate 104, and the work W is pressed. A piece punch 107 is firmly fixed to a lower surface of the upper die base plate 104 in a downward handing manner by a retainer 108.

The piercing process is executed by mounting the work W on the work supporting member 102 and downward moving an upper die 109. Then, the pad 103 first presses the work W, the work W is pierced by the piece punch 107 in accordance with a continuous downward movement of the upper die 109, and the upper die 109 reaches a bottom dead center state shown in FIG. 19.

When the upper die 109 is moved upward after finishing the piercing, the work W which is pierced and attached to the piece punch 107 is taken apart from the pierce punch 107 because the pad 103 is energized toward the lower side by the coil spring 106.

The pad 103 presses the work W for stabilizing before the piercing operation by the pierce punch 107, in order to allow the pierce punch 107 to pierce. Further, the pad 103 has a function of taking away the work W from the pierce punch 107 after being pierced by the pierce punch 107.

Conventionally, at the time of the piercing process, although the pierced portion of the work has a small area, the pad which presses the work and takes the work away from the pierce punch is constituted by a large block body and is manufactured normally by a cast metal. The pad is constituted by the large block body, is heavy, and has increased portions to be machined, whereby an expensive press die is structured. An illustrated example in FIG. 19 shows an example in which the portion to be pierced is a flat surface, however, the pierced portion is normally constituted by a three-dimensional curved surface, so that the pad is formed in accordance with an expensive copying process.

Further, a standardization of the pierce punch has been promoted, however, a standardization of the pierce relevant parts has not been executed, and it is slow to make a design, a manufacture and a product control efficient.

Further, in the press dying, cams such as a passive cam, an actuating cam and the like are used at the time of piercing a side surface of the work as shown in FIG. 18, the standardization of the cam relevant parts has been already achieved, and a high efficiency has been achieved in the design, the manufacture and the product control. However, an association between the standard of the cam relevant parts and the standard of the pierce relevant parts is not achieved.

The present invention has been developed taking the matters mentioned above into consideration and for the following purposes.

(1) To provide inexpensively a pierce die by omitting a large pad at the time of executing a piercing process and pressing a work at only a minimum portion required for the piercing process, thereby reducing the portion to be machined as much as possible.

(2) To standardize pierce relevant parts so as to improve an efficiency in design, manufacturing and product control.

(3) Although the cam relevant parts have been already standardized, to associate the standard of the cam relevant parts and the standard of the pierce relevant parts. In other words, for example, in the case that a pierce punch having a diameter of 10 mm is specified, the cam relevant parts such as the passive cam, the actuating cam and the like used therefor can be specified at the time of piercing the side surface on the basis of the specification, whereby it is possible to achieve a further efficiency in the design, the manufacturing and the product control.

In order to achieve the objects (1), (2) and (3) mentioned above, in accordance with the present invention, there is provided a punch stripper comprising a pierce punch, a punch retainer holding the pierce punch, a cover which covers the pierce punch so as to protrude a leading end portion of the pierce punch, and is fastened by screws to the punch retainer, a stripper which is outward fitted to the pierce punch, presses the work before piercing the work by the pierce punch, takes out the pierce punch from the work after piercing, is received within the cover so as to move forward and backward, and forms a stop flange in a rear end, and a coil spring which is received within the cover so as to bring the stripper into contact with the stop flange, and energizes the stripper toward an outer side.

Further, in order to achieve the objects (1), (2) and (3), in accordance with a specific aspect of the present invention, there is provided a punch stripper, wherein the fitted portion between the stripper and the cover is formed in a non-circular cross sectional shape for preventing the stripper from rotating.

### BRIEF DESCRIPTION OF THE DRAWINGS

FIG. 1 is a front elevational cross sectional view of a top dead center state of a pierce die to which a punch stripper in accordance with the present invention is attached;

FIG. 2 is a front elevational cross sectional view of a bottom dead center state of the pierce die in FIG. 1;

FIG. 3 is a front elevational view of an assembly of a main body mounting type punch stripper in accordance with the present invention;

FIG. 4 is a plan view of the assembly in FIG. 3;

FIG. 5 is a front elevational view of a punch retainer;

FIG. 6 is a plan view of the punch retainer;

FIG. 7 is a front elevational view of a cover;

FIG. 8 is a plan view of the cover;

FIG. 9 is a front elevational view of a positioning and mounting bolt;

FIG. 10 is a plan view of the positioning and mounting bolt;

FIG. 11 is a front elevational view of a stripper;

FIG. 12 is a plan view of the stripper;

FIG. 13 is a side elevational view of the stripper;

FIG. 14 is a front elevational view of an assembly of an outward mounting type punch stripper in accordance with the present invention;

FIG. 15 is a plan view of the assembly in FIG. 14;

FIG. 16 is a front elevational view of a cover of the outward mounting type punch stripper;

FIG. 17 is a plan view of the cover of the outward mounting type punch stripper;

FIG. 18 is a front elevational cross sectional view of a bottom dead center state of a slide cam die to which the punch stripper in accordance with the present invention is attached; and

FIG. 19 is a front elevational view of a conventional pierce die.

### EMBODIMENT

A detailed description of the present invention will be given below on the basis of a specific embodiment shown in the accompanying drawings.

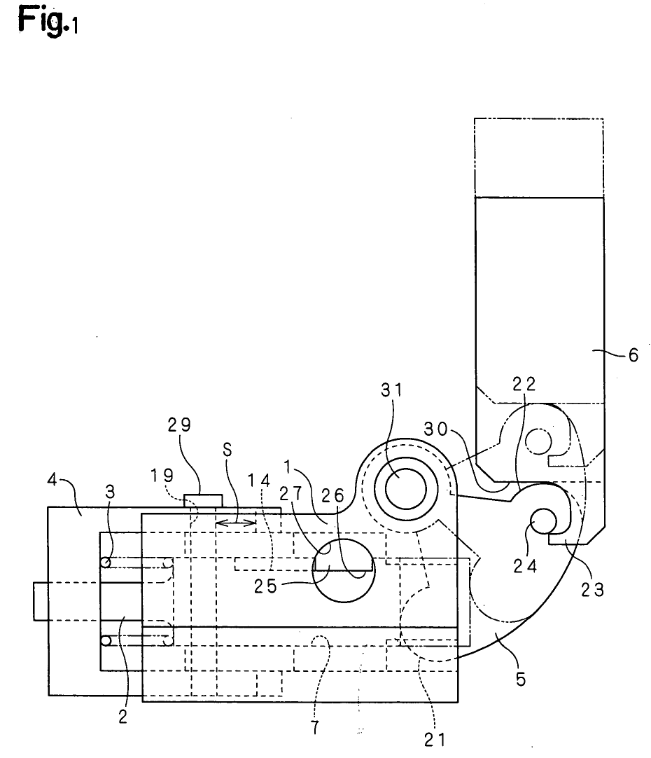

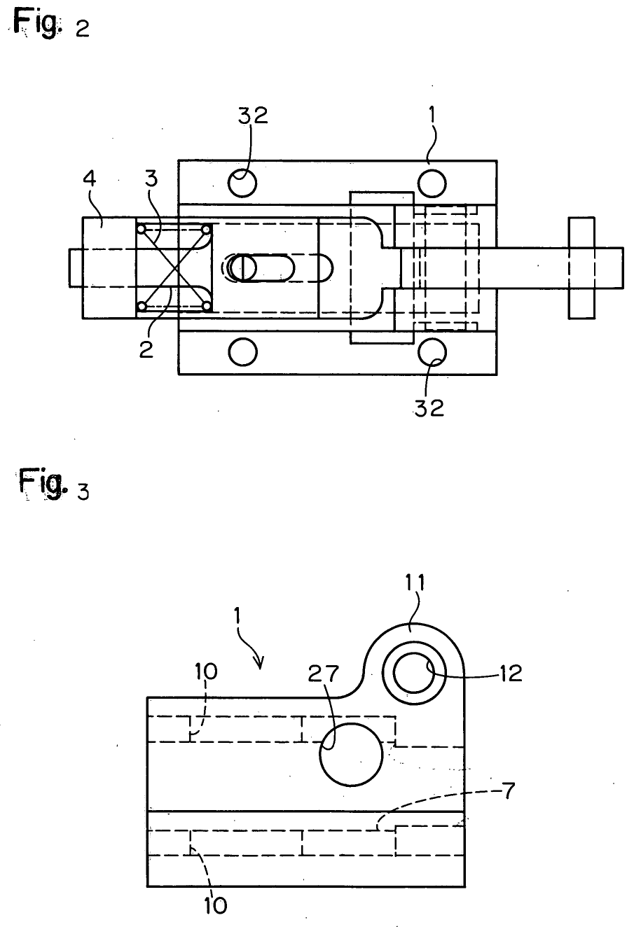

FIG. 1 is a front elevational cross sectional view of a top dead center state of a pierce die to which a punch stripper in accordance with the present invention is attached, and FIG. 2 is a front elevational cross sectional view of a bottom dead center state of the pierce die in FIG. 1.

A work W is mounted on a work supporting member 42 firmly fixed to a lower die base plate 41, and a punch stripper 43 applying a piercing process to the work W is firmly fixed to an upper die base plate 44.

The piercing process is executed by mounting the work W on the work supporting member 42 and downward moving an upper die 45, whereby a stripper 5 first presses the work W, the work W is pierced by a piece punch 1 in accordance with a continuous downward movement of the upper die 45, and the upper die 45 reaches a bottom dead center state shown in FIG. 2.

When the upper die 45 is moved upward after finishing the piercing, the work W which is pierced and attached to the piece punch 1 is taken apart from the pierce punch 1 because the stripper 5 is energized toward a lower side by a coil spring 6.

The stripper 5 presses the work W for stabilizing before the piercing operation by the pierce punch 1, in order to allow the pierce punch 1 to pierce. Further, the stripper 5 has a function of taking away the work W from the pierce punch 1 after being pierced by the pierce punch 1.

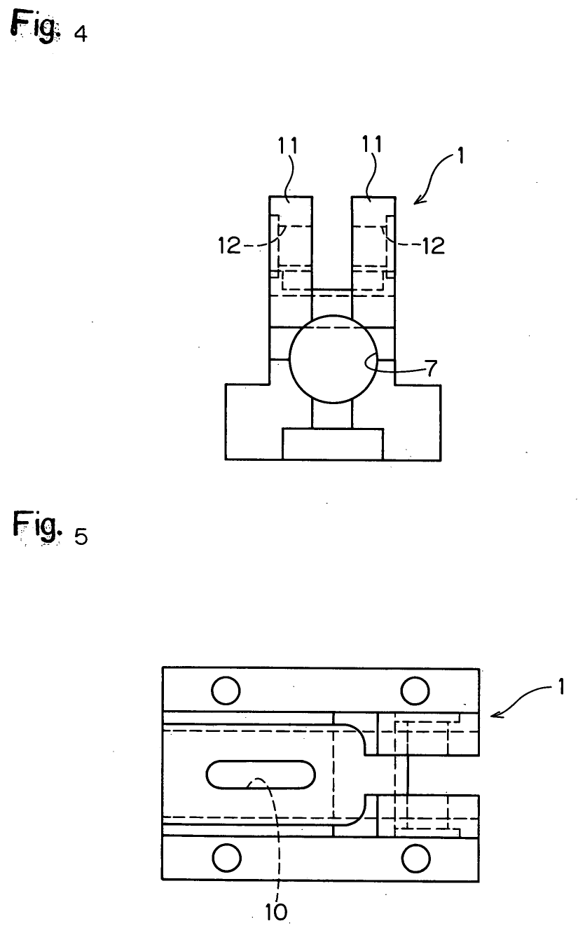

FIG. 3 is a front elevational view of an assembly of a specific embodiment of the punch stripper in accordance with the present invention, and FIG. 4 is a plan view of the assembly in FIG. 3.

The punch stripper in accordance with the present invention is constituted by a pierce punch 1, a punch retainer 2 holding the pierce punch 1, a cover 3 which covers the pierce punch 1 so as to protrude a leading end portion of the pierce punch 1, and is fastened by screws to the punch retainer 2, a stripper 5 which is outward fitted to the pierce punch 1, presses the work W before piercing the work W by the pierce punch 1, takes out the pierce punch 1 from the work W after piercing, is received within the cover 3 so as to move forward and backward, and forms a stop flange 4 in a rear end, and a coil spring 6 which is received within the cover 3 so as to bring the stripper 5 into contact with the stop flange 4, and energizes the stripper 5 toward an outer side.

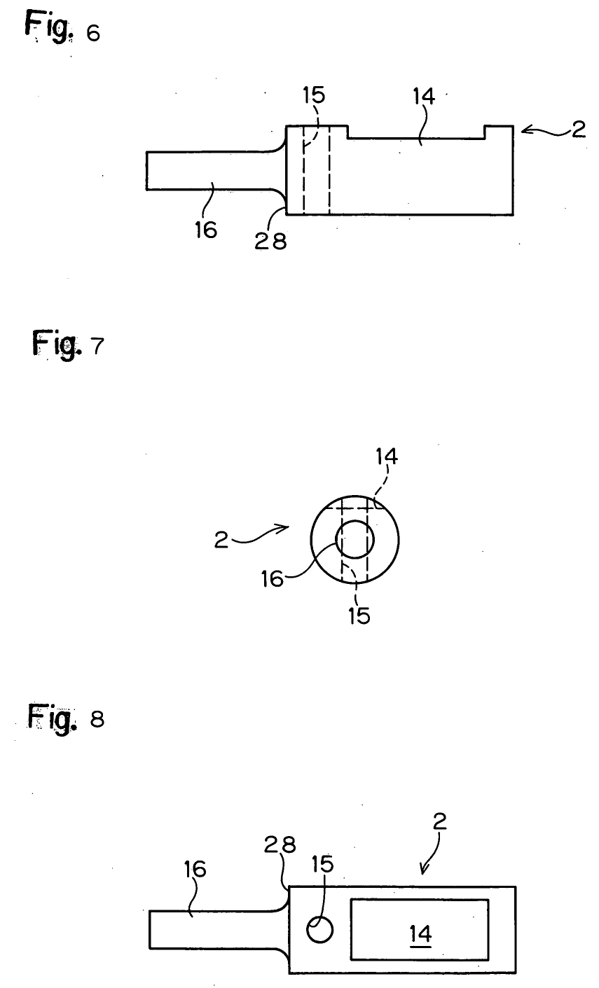

The pierce punch 1 is hardened and ground by a tool steel, and is held to the punch retainer 2 shown in FIGS. 5 and 6. The punch retainer 2 is a plate-like body which is approximately in a triangular shape in a plan view, and is structured such that a holding hole 7 is pierced near a corner, and the pierce punch 1 is pressure inserted to and raised up in the holding hole 7. An engagement flange 8 in a base end of the pierce punch 1 is positioned within an enlarged hole 9. Bolt holes 10 are pierced near the other two corners, and the punch retainer is fastened to the upper die base plate 41 by bolts (not shown) A bolt hole 23 fastens the cover 3 mentioned below.

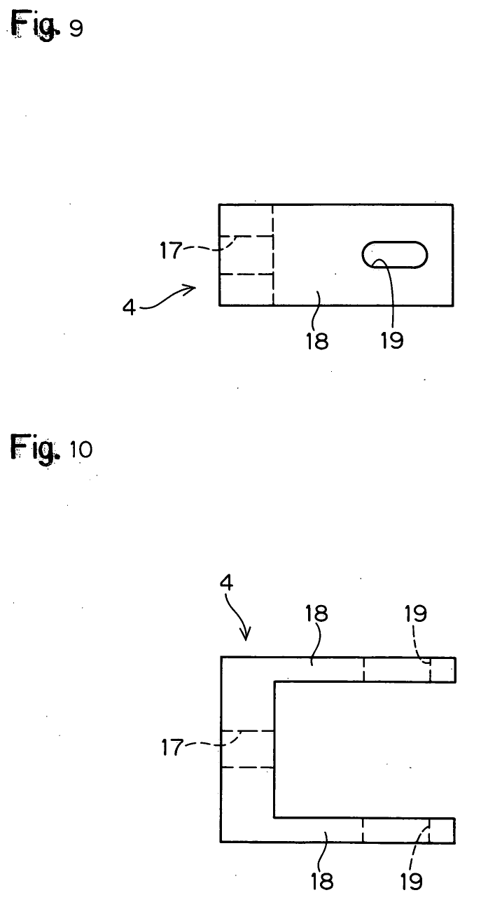

Details of the cover 3 will be shown in FIGS. 7 and 8. The cover 3 covers the pierce punch 1, and is constituted by a tube portion 12 to which the leading end of the pierce punch 1 is protruded, and a mounting portion 13 which is extended to a side portion from the tube portion 12 for fastening the cover 3 to the punch retainer 2 by screws. The tube portion 12 moves the stripper 5 forward and backward, and forms a receiving chamber 14 capable of receiving the coil spring 6, and an oval hole 16 for preventing the stripper 5 from rotating is pierced in an upper wall 15 of the receiving chamber 14. An engagement protruding piece 22 engaging with the punch retainer 2 is protruded from a leading end of the mounting portion 13, a mounting hole 19 through which a positioning and mounting bolt 18 shown in FIGS. 9 and 10 is inserted is pierced in a center portion 13 of the mounting portion, and the positioning and mounting bolt 18 is inserted through the mounting hole 19 so as to be engaged with a thread hole 23 in the punch retainer 2.

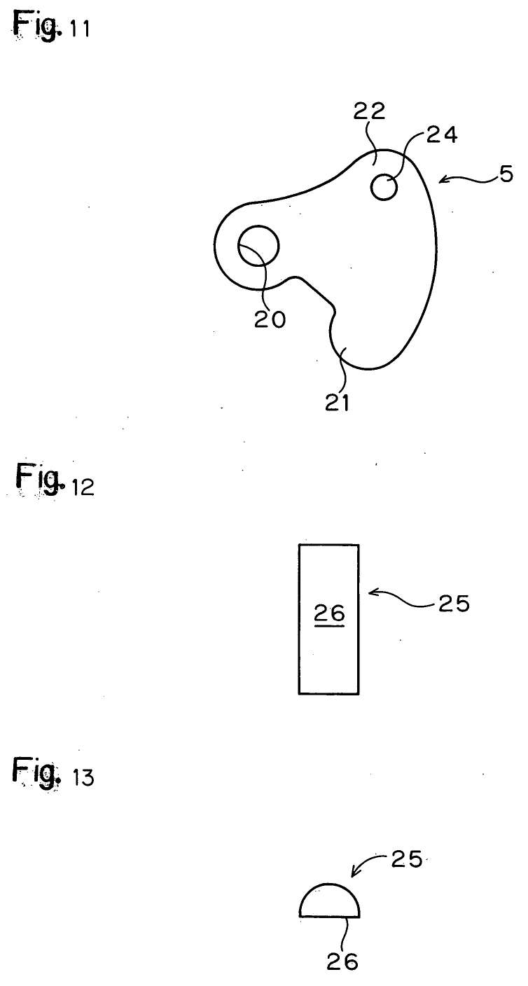

Details of the stripper 5 will be shown in FIGS. 11, 12 and 13. The stripper 5 is outward fitted to the pierce punch 1, presses the work W before piercing the work W by means of the pierce punch 1, takes out the pierce punch 1 from the work W after piercing, is received within the cover 3 so as to move forward and backward, and forms the stop flange 4 at a rear end.

The stripper 5 is received within the receiving chamber 14 of the cover 3 and engages the stop flange 4 at the rear end with the upper wall 15 so as to be protruded forward from the cover 3. An upper end of the coil spring 6 which is received within the receiving chamber 14 of the cover 3 in a contracted manner is brought into contact with the stop flange 4 so as to energize the stripper 5 toward an outer side. When the work W is pressed by the leading end surface 17 of the stripper 5 before piercing the work W by means of the pierce punch 1, and the upper die 45 is moved downward, the stripper 5 moves forward into the receiving chamber 14 of the cover 3, and compresses the coil spring 6 by the stop flange 4. When the leading end surface 17 of the stripper 5 matches to the leading end surface 20 of the pierce punch 1, and the upper die 45 moved downward, the pierce punch 1 pierces the work. When the upper die 45 further moves downward, the pierce punch 1 protrudes into the work. When the upper die 45 starts moving upward, the stripper 5 takes away the work W from the pierce punch 1 because the stripper 5 is energized toward the outer side by the coil spring 6. The receiving chamber 14 of the cover 3 is set so as to apply a stroke required for the pressing force before the work W is pierced, and a stroke required for the take-away force for taking away the work W from the piece punch 1 after the work W is pierced, to the stripper 5.

In the case that the pierce punch pierces a non-circular hole such as a rectangular and the other shapes than a round hole, a rotation stop for the pierce punch is required. In this case, the stripper 5 is formed on an oval diameter outer peripheral surface 21 so as to be fitted to the oval hole 16 of the cover 3.

At the time of piercing process, the leading end surface 17 of the pierce punch 1 is initially immersed into the stripper 5, however, when the upper die 45 moves downward so as to be brought into contact with the work W, the pierce punch 1 moves forward into the receiving chamber 14 of the cover 3, the pierce punch 1 is energized toward the outer side by the coil spring 6, the work W is energized by the stripper 5, and the work W is stabilized before the work W is pierced by the pierce punch 1. When the upper die 45 is moved upward after the work W is pierced by the pierce punch 1, the stripper 5 takes away the pierce punch 1 from the work W because the stripper 5 is energized by the coil spring 6.

When the work has a three-dimensional curved surface, the leading end surface 17 of the stripper 5 is subjected to the copying process after the punch stripper is mounted to the lower die base plate 41, whereby the leading end surface 17 of the stripper 5 is sufficiently brought into contact with the three-dimensional curved surface of the work.

The leading end surface 20 of the piece punch 1 keeps a flat surface, and a sufficient piercing process can be executed by an angle of incline of 10 degree.

The punch stripper mentioned above is of the main body mounting type.

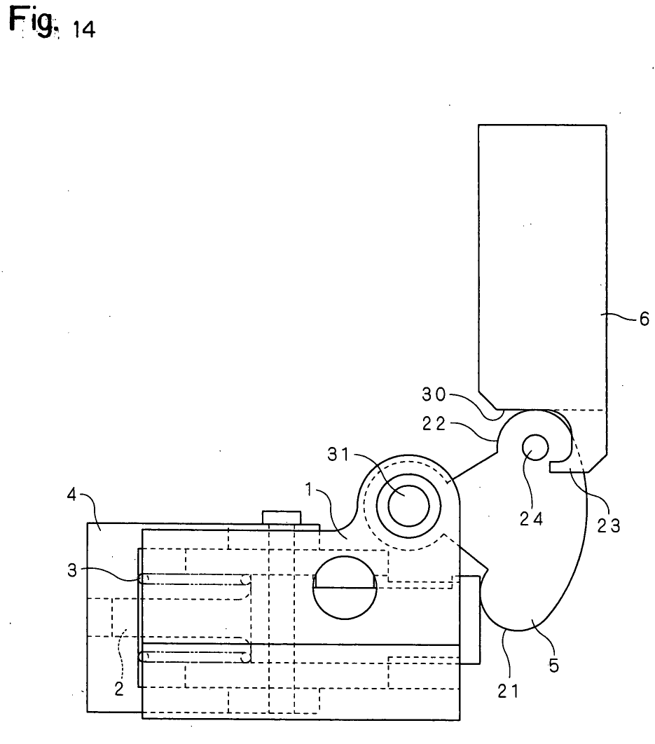

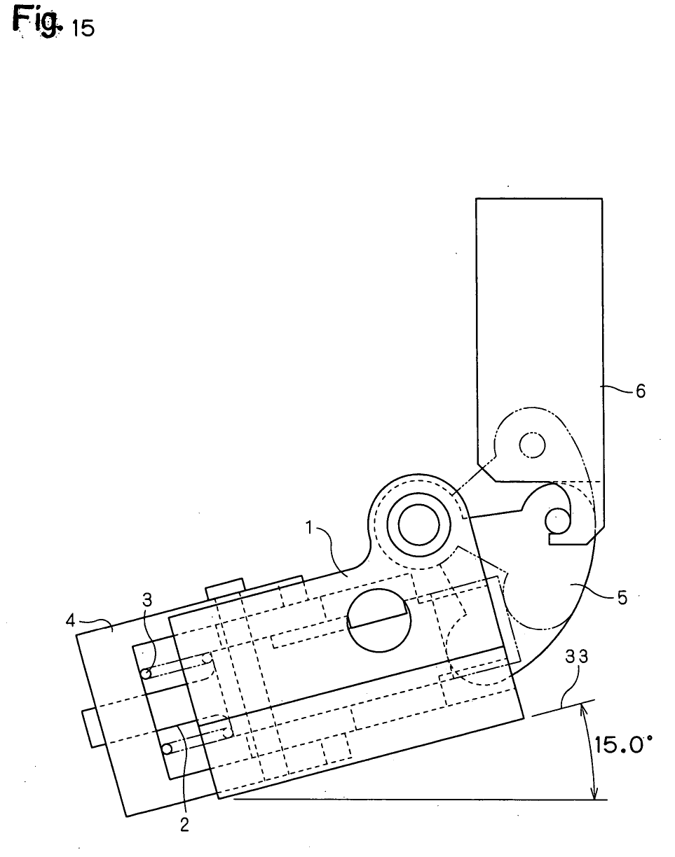

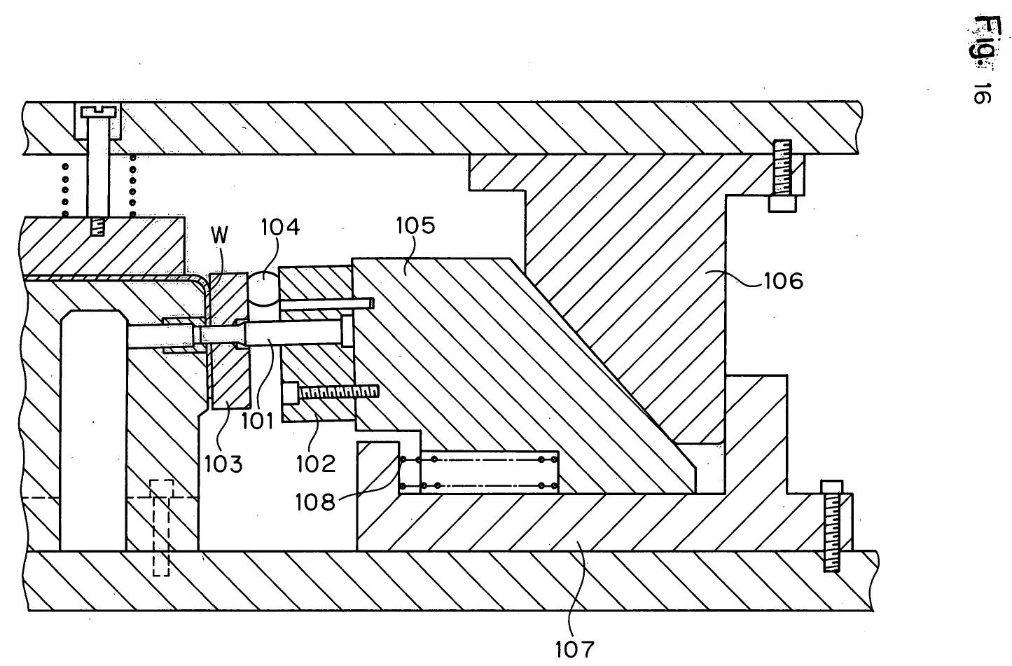

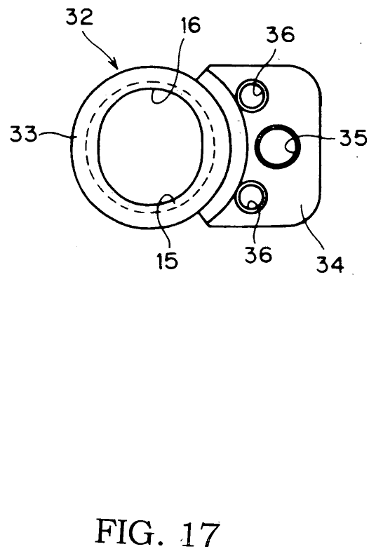

Next, an assembly of an outward mounting type punch stripper will be shown in FIGS. 14 and 15.

A punch retainer and a stripper of the outward mounting type punch stripper are absolutely the same as those of the main body mounting type punch stripper, however, a cover thereof is different therefrom.

The outward mounting type punch stripper is constituted by a pierce punch 31, a punch retainer 2 which holds the pierce punch 31, a cover 32 which covers the pierce punch 31, protrudes a leading end portion of the pierce punch 31 and is fastened by screw to the punch retainer 2, a stripper 5 which is outward fitted to the pierce punch 31, presses the work before the work is pierced by the pierce punch 31, takes out the pierce punch from the work after piercing, is received within the cover 32 so as to be moved forward and backward, and forms a stop flange 4 at a rear end, and a coil spring 6 which is received within the cover 32, is brought into contact with the stop flange 4 of the stripper 5 and energizes the stripper 5 toward an outer side.

Details of the cover 32 will be shown in FIGS. 14 and 15. The cover 31 is constituted by a tube body 33 which covers the pierce punch 31 and protrudes the leading end of the pierce punch 31, and amounting portion 34 which extends to a lower side portion of the tube body 33 for fastening by screw the cover 31 to the outward mounting portion. The tube body 33 is absolutely the same as the tube body 12 of the main body mounting type, and the same reference numeral is attached thereto. A bolt hole 35 for fastening by screw to the outward mounting portion and a knock pin hole 36 for positioning are pierced in the mounting portion 34.

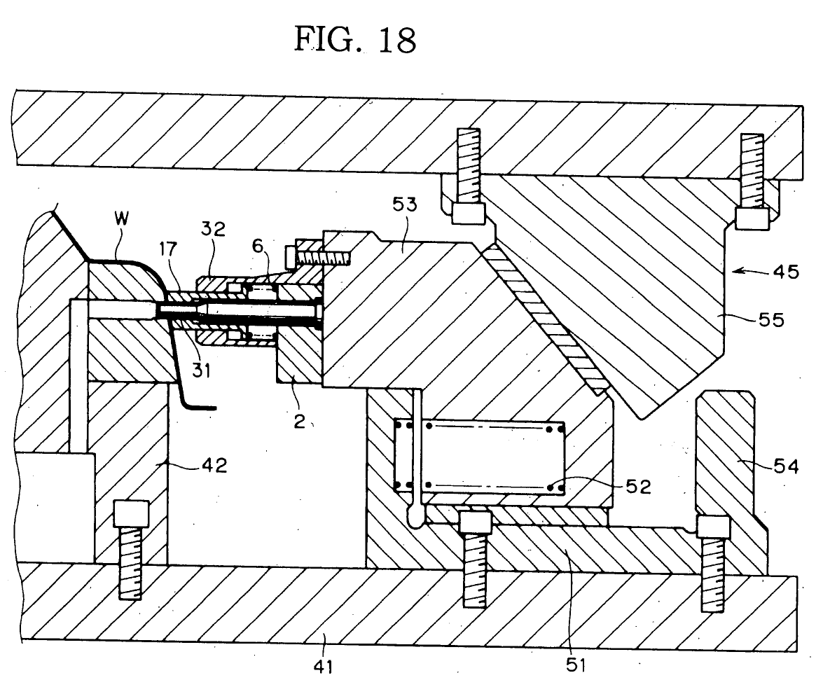

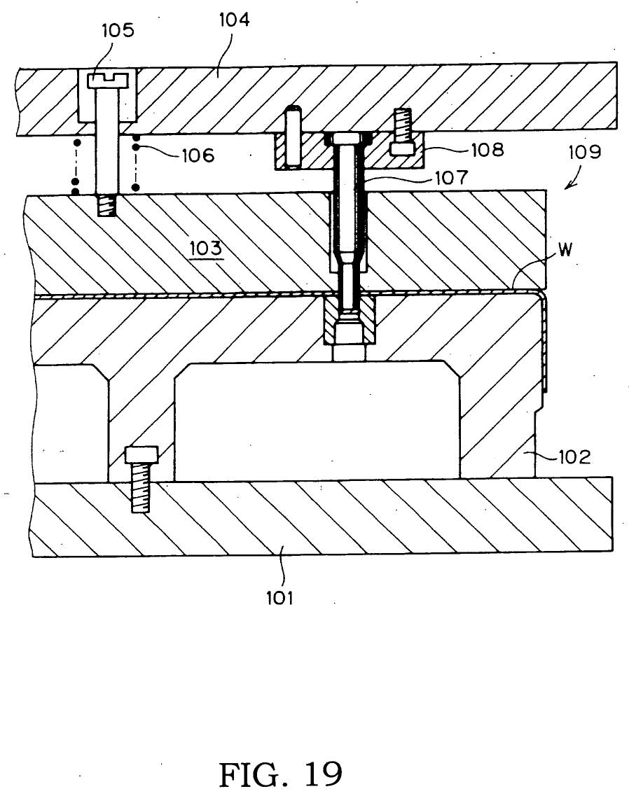

An example in which the present outward mounting type punch stripper is mounted to the slide cam die will be shown in FIG. 18. FIG. 18 shows a bottom dead center state.

The work W is mounted on a work supporting member 42 firmly fixed to a lower die base plate 41, a heel 51 is firmly fixed to the lower die base plate 41, the heel 51 is provided slidably with a passive cam 53 which is energized to an outer side (in a right direction as facing to the drawing) by an elastic coil spring 52, and the passive cam 53 is brought into contact with a stop plate 54 of the heel 51 at a position where an upper die 45 is positioned at a top dead center. An actuating cam 55 driven while being brought into contact with the passive cam 53 is firmly fixed to an upper die base plate 44.

The punch retainer 2 holding the pierce punch 31 is firmly fixed to the passive cam 53, a stripper 17 which is outward fitted to the pierce punch 31 and is energized in a direction of the work W by the coil spring 6 is provided, and the cover 32 which is outward fitted to the stripper 17 and guides the stripper 17 is firmly fixed to the passive cam 53.

In a state in which the upper die 45 is at the top dead center, the pierce punch 31 is positioned within the stripper, and the upper die 45 is moved downward. When the actuating cam 55 is brought into contact with the passive cam 53 so as to drive the passive cam 53, the stripper 17 is brought into contact with the work W, and the work W is pierced by the pierce punch 31. When the upper die 45 is moved upward after piercing, the pierce punch 31 within the work W is pulled out on the basis of the energizing force of the stripper 17.

The outward mounting type punch stripper and the main body mounting type punch stripper are not essentially different from each other, but are different only in the mounting portion of the punch stripper.

Further, the main body mounting type punch stripper and the outward mounting type punch stripper have the following features.

Since the cover is structured by integrally forming the tube portion and the mounting portion, an accuracy of the punch stripper is improved in comparison with the separate structure.

Further, since the coil spring is employed for energizing the stripper instead of an urethane rubber, it is possible to move the stripper for a long distance, and it is possible to prevent the stripper from being compressed so as to be broken. Since the urethane rubber is expanded due to the compression, the urethane rubber cannot be used for the compact punch stripper, and can execute only a slight compression.

Further, since the mounting bolt for the cover is visible from the outside in the present punch stripper, it is possible to easily detach the punch stripper.

In addition, in the present punch stripper, the accuracy of the pierce punch is held by setting the length of the fitted portion between the stripper and the cover long.

In the main body mounting type punch stripper, a mounting portion has a size of 55 mm×60 mm, and a height of 98 mm.

The present punch stripper is described with respect to the piercing process, however, can be applied to a notching process or the like.

In accordance with the present invention, as mentioned above, since the punch stripper is constituted by the pierce punch, the punch retainer which holds the pierce punch, the cover which covers the pierce punch, protrudes the leading end portion of the pierce punch and is fastened by screw to the punch retainer, the stripper which is outward fitted to the pierce punch, presses the work before the work is pierced by the pierce punch, takes out the pierce punch from the work after piercing, is received within the cover so as to be moved forward and backward, and forms the stop flange at a rear end, and the coil spring which is received within the cover, is brought into contact with the stop flange of the stripper and energizes the stripper toward the outer side, it is possible to achieve the objects (1), (2) and (3) mentioned above.

Further, in accordance with the present invention, in specific, since the fitted portion between the stripper and the cover is constituted by the punch stripper formed in the non-circular cross sectional shape for preventing the stripper from rotating, it is possible to achieve the objects (1), (2) and (3) mentioned above.

1. A punch stripper comprising:
a pierce punch;
a punch retainer holding the pierce punch;
a cover which covers the pierce punch so as to protrude a leading end portion of the pierce punch, and is fastened by screws to the punch retainer;
a stripper which is outward fitted to the pierce punch, presses the work before piercing the work by the pierce punch, takes out the pierce punch from the work after piercing, is received within the cover so as to move forward and backward, and forms a stop flange in a rear end; and
a coil spring which is received within the cover so as to bring the stripper into contact with the stop flange, and energizes the stripper toward an outer side.

2. A punch stripper as claimed in claim 1, wherein the fitted portion between the stripper and the cover is formed in a non-circular cross sectional shape for preventing the stripper from rotating.
